(19) United States
(12) Patent Application Publication
(10) Pub. No.: US 2013/0150243 A1
(43) Pub. Date: Jun. 13, 2013

(54) METHOD OF CONTROLLING PEST

(71) Applicant: Sumitomo Chemical Company, Limited, Tokyo (JP)

(72) Inventor: Yoshinao SADA, Tokyo (JP)

(73) Assignee: SUMITOMO CHEMICAL COMPANY, LIMITED, Tokyo (JP)

(21) Appl. No.: 13/686,996

(22) Filed: Nov. 28, 2012

(30) Foreign Application Priority Data
Dec. 8, 2011 (JP) 2011-268616

(51) Int. Cl. A01N 43/84; A01N 37/28; A01N 31/14; A01N 43/653; A01N 43/54

(52) U.S. Cl. CPC A01N 43/84; A01N 43/653; A01N 43/54; A01N 31/14; A01N 37/28
USPC 504/225; 504/273; 504/243; 504/352; 504/333

(57) ABSTRACT

Provided is a method which exerts an excellent effect in controlling a pest in a field of cotton, using a neonicotinoid compound, an azole compound, a strobilurin compound, and/or a metalaxyl compound, and a PPO inhibiting compound. A method of controlling a pest (a weed, a harmful arthropod, and/or a plant pathogen) in a field of cotton, including treating a field before, at or after seeding with a seed of cotton treated with one or more compounds selected from the group consisting of a neonicotinoid compound, an azole compound, a strobilurin compound and a metalaxyl compound, with one or more PPO-inhibiting compounds selected from the group consisting of flumioxazin, sulfentrazone, saflufenacil, oxyfluorfen, fomesafen and a compound of the formula:

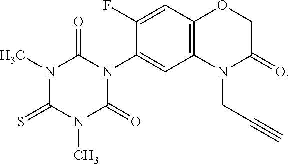 [SMILES: C#CCN1C(=O)COc2cc(F)c(-n3c(=O)n(C)c(=S)n(C)c3=O)cc21]

### BACKGROUND OF THE INVENTION

1. Field of the Invention

The present invention relates to a method of controlling a pest, that is, a harmful arthropod, a plant pathogen and a weed.

2. Description of the Related Art

A neonicotinoid compound has been known as an active ingredient of an insecticide. An azole compound has been known as an active ingredient of a fungicide. A strobilurin compound has been known as an active ingredient of a fungicide. A metalaxyl compound has been known as an ingredient of a fungicide. A PPO-inhibiting compound has been known as an active ingredient of a herbicide.

### PRIOR ART LITERATURE

### Patent Literature

Patent Literature 1: WO 02/066471

### Non-Patent Literature

Non-Patent Literature 1: Crop Protection Handbook, vol. 96 (2010)

### SUMMARY OF THE INVENTION

The present invention provides a method which exerts excellent effects in controlling a pest in a field of cotton.

The present invention relates to the followings.

[1] A method of controlling a weed in a field of cotton, comprising applying one or more PPO-inhibiting compounds selected from the group consisting of flumioxazin, sulfentrazone, saflufenacil, oxyfluorfen, fomesafen and a compound of the formula:

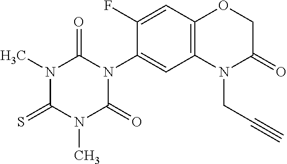 [SMILES: C#CCN1C(=O)COc2cc(F)c(-n3c(=O)n(C)c(=S)n(C)c3=O)cc21]

to a field before, at or after seeding with a seed of cotton treated with one or more compounds selected from the group consisting of a neonicotinoid compound, an azole compound, a strobilurin compound and a metalaxyl compound.

[2] A method of controlling a pest in a field of cotton, comprising steps of:

treating a seed of cotton with one or more compounds selected from the group (I) consisting of a neonicotinoid compound, an azole compound, a strobilurin compound and a metalaxyl compound, and

treating a field before, at or after seeding with the seed of cotton treated with one or more compounds selected from the group (I), with one or more PPO-inhibiting compounds selected from the group consisting of flumioxazin, sulfentrazone, saflufenacil, oxyfluorfen, fomesafen and a compound of the formula:

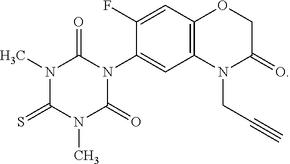 [SMILES: C#CCN1C(=O)COc2cc(F)c(-n3c(=O)n(C)c(=S)n(C)c3=O)cc21]

[3] The method of controlling a pest according to [1] or [2], wherein the neonicotinoid compound is one selected from the group consisting of clothianidin, thiamethoxam, imidacloprid, dinotefuran, nitenpyram, acetamiprid and thiacloprid.

[4] The method of controlling a pest according to [1] or [2], wherein the neonicotinoid compound is clothianidin or thiamethoxam.

[5] The method of controlling a pest according to [4], wherein the PPO-inhibiting compound is flumioxazin or fomesafen.

[6] The method of controlling a pest according to [1] or [2], wherein the azole compound is one selected from the group consisting of azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz and triflumizole.

[7] The method of controlling a pest according to [1] or [2], wherein the azole compound is one selected from the group consisting of difenoconazole, ipconazole, metconazole, tebuconazole, triadimenol, myclobutanil, triticonazole and fluquinconazole.

[8] The method of controlling a pest according to [7], wherein the PPO-inhibiting compound is flumioxazin or fomesafen.

[9] The method of controlling a pest according to [1] or [2], wherein the strobilurin compound is one selected from the group consisting of kresoxim-methyl, azoxystrobin, trifloxystrobin, fluoxastrobin, picoxystrobin, pyraclostrobin, dimoxystrobin, pyribencarb, metominostrobin and orysastrobin.

[10] The method of controlling a pest according to [1] or [2], wherein the strobilurin compound is azoxystrobin, trifloxystrobin or pyraclostrobin.

[11] The method of controlling a pest according to [10], wherein the PPO-inhibiting compound is flumioxazin or fomesafen.

[12] The method of controlling a pest according to [1] or [2], wherein the metalaxyl compound is metalaxyl or metalaxyl-M.

[13] The method of controlling a pest according to [12], wherein the PPO-inhibiting compound is flumioxazin or fomesafen.

[14] The method of controlling a pest according to [2], comprising a step of treating the field before seeding with the seed of cotton, with the PPO-inhibiting compound.

[15]. The method of controlling a pest according to [2], comprising a step of treating the field to be seeded, with the PPO-inhibiting compound simultaneously at seeding with the seed of cotton.

[16] The method of controlling a pest according to [2], comprising a step of treating the field after seeding with the seed of cotton, with the PPO-inhibiting compound.

[17] The method of controlling a pest according to [2], wherein the pest is a weed, a harmful arthropod, and/or a plant pathogen.

[18] The method of controlling a pest according to [2], wherein the pest is a weed.

### DETAILED DESCRIPTION OF THE PREFERRED EMBODIMENTS

The method of controlling a pest of the present invention includes steps of:

(1) treating a seed of cotton with one or more compounds selected from the group (I) consisting of a neonicotinoid compound, an azole compound, a strobilurin compound and a metalaxyl compound, and

(2) treating a field before, at or after seeding with the seed of cotton treated with one or more compounds selected from the group (I), with one or more PPO-inhibiting compounds selected from the group consisting of flumioxazin, sulfentrazone, saflufenacil, oxyfluorfen, fomesafen and a compound of the formula:

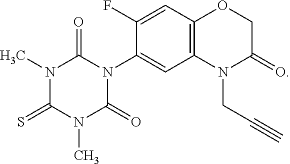 [SMILES: C#CCN1C(=O)COc2cc(F)c(-n3c(=O)n(C)c(=S)n(C)c3=O)cc21]

In the present invention, the seed of cotton is not limited as far as it is a variety which is generally cultivated as a crop.

Examples of a plant of such a variety include plants to which resistance to a PPO-inhibiting compound such as flumioxazin; a 4-hydroxyphenylpyruvate dioxygenase-inhibiting compound such as isoxaflutole; an acetolactate synthase (hereinafter abbreviated as ALS)-inhibiting compound such as imazethapyr or thifensulfuron methyl; a 5-enolpyruvylshikimate-3-phosphate synthase (hereinafter, abbreviated as EPSP) inhibitor such as glyphosate; a glutamine synthase inhibitor such as glufosinate; an auxin-type herbicide such as 2,4-D or dicamba; or bromoxynil has been imparted by a classical breeding method or a genetic engineering technique.

Examples of a crop to which resistance has been imparted by a classical breeding method include cotton resistant to an imidazolinone type ALS inhibiting herbicide such as imazethapyr under a trade name of Clearfield (registered trademark).

Examples of a plant to which resistance has been imparted by a genetic engineering technique include cotton variety which is resistant to glyphosate, and it has already been commercially available under trade names of RoundupReady (registered trade mark), RoundupReadyFLEX (registered trademark), Gly-Tol (registered trademark) and the like. Similarly, there is cotton variety which is resistant to glufosinate by a genetic engineering technique, and it has already been commercially available under trade names of LibertyLink (registered trademark) and the like. Similarly, there is cotton variety which is resistant to bromoxynil by a genetic engineering technique, and this has already been commercially available under the trade name of BXN (registered trademark).

Cotton variety which is resistant to dicamba can be produced by introducing a dicamba degrading enzyme such as dicamba monooxygenase isolated from Pseudomonas maltophilia into a plant (Behrens et al. 2007 Science 316: 1185-1188).

By introducing a gene encoding aryloxyalkanoate dioxygenase, cotton which becomes resistant to a phenoxy acid-type herbicide such as 2,4-D, MCPA, dichlorprop or mecoprop, and an aryloxyphenoxypropionic acid-type herbicide such as quizalofop, haloxyfop, fluazifop, diclofop, fenoxaprop, metamifop, cyhalofop and clodinafop can be produced (Wright et al. 2010: Proceedings of National Academy of Science. 107 (47): 20240-20245).

The crop includes, for example, a crop which has become possible to synthesize a selective toxin known in Bacillus genus, using a genetic engineering technique.

Examples of the toxin which is expressed in such a genetically engineered plant include an insecticidal protein derived from Bacillus cereus or Bacillus popilliae; a δ-endotoxin such as Cry1Ab, Cry1Ac, Cry1F, Cry1Fa2, Cry2Ab, Cry3A, Cry3Bb1 or Cry9C, derived from Bacillus thuringiensis; an insecticidal protein such as VIP1, VIP2, VIP3 or VIP3A; an insecticidal protein derived from nematode; a toxin produced by an animal such as a scorpion toxin, a spider toxin, a bee toxin or an insect-specific neurotoxin; a filamentous fungus toxin; plant lectin; agglutinin; a protease inhibitor such as a trypsin inhibitor, a serine protease inhibitor, patatin, cystatin, and a papain inhibitor; a ribosome inactivating protein (RIP) such as lysine, corn-RIP, abrin, luffin, saporin or bryodin; a steroid metabolism enzyme such as 3-hydroxysteroid oxidase, ecdysteroid-UDP-glycosyltransferase, and cholesterol oxidase; an ecdysone inhibitor; HMG-CoA reductase; an ion channel inhibitor such as a sodium channel inhibitor or a calcium channel inhibitor; juvenile hormone esterase; a diuretic hormone receptor; stilbene synthase; bibenzyl synthase; chitinase; glucanase; and the like.

A toxin expressed by such a genetically engineered crop includes a hybrid toxin of a δ-endotoxin protein such as Cry1Ab, Cry1Ac, Cry1F, Cry1Fa2, Cry2Ab, Cry3A, Cry3Bb1, Cry9C, Cry34Ab or Cry35Ab, and an insecticidal protein such as VIP1, VIP2, VIP3 or VIP3A, and a partially deleted toxin, and a modified toxin. The hybrid toxin can be produced by a new combination of different domains of these proteins using a genetic engineering technique. As the partially deleted toxin, Cry1Ab in which a part of an amino acid sequence has been deleted is known. In the modified toxin, one or a plurality of amino acids of a natural toxin are substituted. Examples of these toxins and recombinant plants which can synthesize these toxins are described in EP-A-0374753, WO 93/07278, WO 95/34656, EP-A-0427529, EP-A-451878, WO 03/052073 and the like. The toxins contained in these recombinant plans impart resistance to Coleoptera vermin, Diptera vermin and Lepidoptera vermin to a plant.

In addition, genetically engineered cotton containing one or a plurality of insecticidal vermin-resistant genes and expressing one or a plurality of toxins have already been known, and some of them are commercially available. Examples of the genetically engineered cotton include BollGard (registered trademark) (cotton variety expressing Cry1Ac toxin), BollGard (registered trademark) II (cotton variety expressing Cry1Ac and Cry2Ab toxins), BollGard (registered trademark) III (cotton variety expressing Cry1Ac, Cry2Ab and VIP3A toxins), VipCot (registered trademark) (cotton variety expressing VIP3A and Cry1Ab toxins), WideStrike (registered trademark) (cotton variety expressing Cry1Ac and Cry1F toxins).

Examples of the plant used in the present invention also include plants to which resistance to an aphid has been imparted, such as soybeans into which a Rag1 (Resistance Aphid Gene 1) gene has been introduced.

The crop also includes a crop to which the ability to produce an anti-pathogenic substance having selective action has been imparted using a genetic engineering technique. As an example of the anti-pathogenic substance, a PR protein and the like are known (PRPs, EP-A-0392225). Such an anti-pathogenic substance and a genetically engineered plant producing the substance are described in EP-A-0392225, WO 95/33818, EP-A-0353191 and the like. Examples of the anti-pathogenic substance expressed in such a genetically engineered plant include an ion channel inhibitor such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and an anti-pathogenic substance generated by microorganisms, such as a peptide antibiotic, an antibiotic having a hetero ring, or a protein factor associated with resistance to plant diseases (which is called a plant disease-resistant gene and is described in WO 03/000906).

The crop also includes a plant to which a useful character such as oil cake component modification or an amino acid content enhancing character has been imparted using a genetic engineering technique.

Further, stack varieties are also included in which a plurality of the classical herbicide character or herbicide-resistant gene, insecticidal vermin-resistant gene, anti-pathogenic substance production gene, and a useful character such as oil cake component modification or amino acid content enhancing character are combined.

In the present invention, one kind or a plurality of kinds of compounds of the group (I) may be used.

The neonicotinoid compound is preferably a compound selected from the group consisting of clothianidin, thiamethoxam, imidacloprid, dinotefuran, nitenpyram, acetamiprid and thiacloprid, more preferably clothianidin or thiamethoxam, further preferably clothianidin.

In the present invention, the azole compound is a compound having a 5-membered heterocyclic structure having a nitrogen atom and, generally, exhibits an action of inhibiting demethylation in the course of biosynthesis of ergosterol or an analog thereof contained in a cellular membrane of fungi. The azole compound is also called a DMI agent (demethylation inhibitor) (see, The Frontiers of Agrobioregulators, 2003).

The azole compound is preferably a compound selected from the group consisting of azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz and triflumizole, more preferably a compound selected from the group consisting of difenoconazole, triadimenol, metconazole, ipconazole, fluquinconazole, myclobutanil, tebuconazole and triticonazole.

The strobilurin compound is also called a QoI compound and, generally, exhibits a plant disease controlling activity by acting on the Qo site of the mitochondrial electron transport system complex of filamentous fungus.

The strobilurin compound is a compound selected from the group consisting of kresoxim-methyl, azoxystrobin, trifloxystrobin, fluoxastrobin, picoxystrobin, pyraclostrobin, dimoxystrobin, pyribencarb, metominostrobin and orysastrobin, more preferably pyraclostrobin, azoxystrobin, dimoxystrobin or trifloxystrobin, further preferably pyraclostrobin, azoxystrobin or trifloxystrobin, particularly preferably pyraclostrobin.

The metalaxyl compound generally exhibits an action of controlling a plant disease derived from Phycomycetes. The metalaxyl compound is preferably metalaxyl or metalaxyl-M. Metalaxyl-M is also called mefenoxam.

In the present invention, in the step of treating a seed of cotton with the compound of the group (I), the compound of the group (I) is usually used by formulating into a preparation by mixing with a carrier such as a solid carrier or a liquid carrier and, further, if necessary, adding an auxiliary agent for a preparation such as a surfactant.

The compound of the group (I) is applied at an amount in a range of usually 0.001 to 40 g, preferably 0.01 to 10 g per 1 kg of the seed. Examples of a method of applying an active ingredient (i.e., the compound of group (I)) to a seed of a plant include a method of covering a seed with a preparation containing an active ingredient; a method of immersing a seed in a preparation containing an active ingredient; and a method of coating a seed with a carrier containing an active ingredient.

In the present invention, there is a step of treating a field before, at or after seeding with a seed of cotton treated with the compound of the group (I), with one or more PPO-inhibiting compounds.

The PPO-inhibiting compound is a herbicidally active compound which inhibits protoporphyrinogen IX oxidase (EC1.3.3.4) located on a chlorophyll synthesis pathway in a plastid of a plant and, as a result, leads to withering of the plant.

The PPO-inhibiting compound in the present invention is flumioxazin, sulfentrazone, saflufenacil, oxyfluorfen, fomesafen and a compound of the formula:

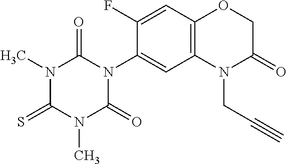 [SMILES: C#CCN1C(=O)COc2cc(F)c(-n3c(=O)n(C)c(=S)n(C)c3=O)cc21]

(hereinafter, may be called compound A). In the present invention, fomesafen includes a free body and sodium salt of fomesafen.

In the step of treating the field with the PPO-inhibiting compound, the PPO-inhibiting compound is usually mixed with a solid carrier or a liquid carrier, formulated with optional addition of an auxiliary agent for formulation such as a surfactant, and then used.

Examples of a method of treating the field with the PPO-inhibiting compound include a method of applying the PPO-inhibiting compound to a soil of the field and a method of applying the PPO-inhibiting compound to a weed after its emergence.

A does of the PPO-inhibiting compound used in the step of treating a field with the PPO-inhibiting compound is usually in the range of 5 to 5000 g per 10000 m². In the step of treating a field with the PPO-inhibiting compound, an adjuvant may be mixed upon treatment with the PPO-inhibiting compound.

The seed of cotton treated with the group (I) is seeded on a field by a conventional method. In the method of controlling a pest of the present invention, the PPO-inhibiting compound may be applied before seeding with the seed of cotton, may be applied simultaneously at seeding with the seed of cotton or may be applied after seeding with the seed of cotton.

When a field is treated with the PPO-inhibiting compound before seeding with the cotton seed, the field is treated with the PPO-inhibiting compound 50 days before seeding to immediately before seeding, preferably 30 days before seeding to immediately before seeding, further preferably 20 days before seeding to immediately before seeding.

When a field is treated with the PPO-inhibiting compound after seeding with the cotton seed, the field is treated with the PPO-inhibiting compound immediately after seeding to 70 days after seeding, preferably 30 days after seeding to 50 days after seeding. Examples of a specific treating term when a field is treated with the PPO-inhibiting compound after seeding with the cotton seed include pre-emergence to flowering of the cotton. Preferred is a lignification initiation term of the stem base of the cotton to a term when a lignification portion is 20 cm from the base.

According to the method of controlling a pest of the present invention, a pest such as a harmful arthropod/or a plant pathogen, and a weed in a field of cotton can be controlled.

Examples of the harmful arthropod include the followings:

Hemiptera vermin: Delphacidae such as Laodelphax striatellus, Nilaparvata lugens, and Sogatella furcifera; Deltocephalidae such as Nephotettix cincticeps and Nephotettix virescens; Aphididae such as Aphis gossypii, Myzus persicae, Brevicoryne brassicae, Macrosiphum euphorbiae, Aulacorthum solani, Rhopalosiphum padi, and Toxoptera citricidus; Pentatomidae such as Nezara antennata, Riptortus clavetus, Leptocorisa chinensis, Eysarcoris parvus, Halyomorpha mista, and Lygus lineolaris; Aleyrodidae such as Trialeurodes vaporariorum, Bemisia tabaci, and Bemisia argentifolii; Coccidae such as Aonidiella aurantii, Comstockaspis perniciosa, Unaspis citri, Ceroplastes rubens, and Icerya purchasi; Tingidae; Psyllidae; and the like;

Lepidoptera vermin: Pyralidae such as Chilo suppressalis, Tryporyza incertulas, Cnaphalocrocis medinalis, Notarcha derogata, Plodia interpunctella, Ostrinia furnacalis, Ostrinia nubilaris, Hellula undalis, and Pediasia teterrellus; Noctuidae such as Spodoptera litura, Spodoptera exigua, Pseudaletia separata, Mamestra brassicae, Agrotis ipsilon, Plusia nigrisigna, Trichoplusia spp., Heliothis spp., and Helicoverpa spp.; Pieridae such as Pieris rapae; Adoxophyes spp.; Tortricidae such as Grapholita molesta, Leguminivora glycinivorella, Matsumuraeses azukivora, Adoxophyes orana fasciata, Adoxophyes sp., Homona magnanima, Archips fuscocupreanus, and Cydia pomonella; Gracillariidae such as Caloptilia theivora and Phyllonorycter ringoneella; Carposinidae such as Carposina niponensis; Lyonetiidae such as Lyonetia spp.; Lymantriidae such as Lymantriidae spp. and Euproctis spp.; Yponameutidae such as Plutella xylostella, Gelechiidae such as Pectinophora gossypiella and Phthorimaea operculella; Arctiidae such as Hyphantria cunea; Tineidae such as Tinea translucens and Tineola bisselliella; and the like;

Thysanoptera vermin: Thripidae such as Frankliniella occidentalis, Thrips parmi, Scirtothrips dorsalis, Thrips tabaci, Frankliniella intonsa, and Frankliniella fusca; and the like;

Diptera vermin: Agromyzidae such as Musca domestica, Culex popiens pallens, Tabanus trigonus, Hylemya antiqua, Hylemya platura, Anopheles sinensis, Agromyza oryzae, Hydrellia griseola, Chlorops oryzae, and Liriomyza trifolii; Dacus cucurbitae, Ceratitis capitata, and the like;

Coleoptera vermin: Epilachna vigintioctopunctata, Aulacophora femoralis, Phyllotreta striolata, Oulema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata, Agriotes spp., Lasioderma serricorne, Anthrenus verbasci, Tribolium castaneum, Lyctus brunneus, Anoplophora malasiaca, Tomicus piniperda, and the like;

Orthoptera vermin: Locusta migratoria, Gryllotalpa africana, Oxya yezoensis, Oxya japonica, and the like;

Hymenoptera vermin: Athalia rosae, Acromyrmex spp., Solenopsis spp., and the like;

Blattidae vermin: Blattella germanica, Periplaneta fuliginosa, Periplaneta americana, Periplaneta brunnea, Blatta orientalis, and the like;

Acarina vermin: Tetranychidae such as Tetranychus urticae, Panonychus citri, and Oligonychus spp.; Eriophyidae such as Aculops pelekassi; Tarsonemidae such as Polyphagotarsonemus latus; Tenuipalpidae; Tuckerellidae; Acaridae such as Tyrophagus putrescentiae; Dermanyssidae such as Dermatophagoides farinae and Dermatophagoides ptrenyssnus; Cheyletidae such as Cheyletus eruditus, Cheyletus malaccensis, and Cheyletus moorei; and the like.

Examples of the plant pathogen include the followings:

Cercospora gossypina, Phakopsora gossypii, Rhizoctonia solani, Colletotrichum gossypii, Peronospora gossypina, Phyotophthora spp., Pythium spp., Aspergillus spp., Penicillium spp., Fusarium spp., Tricoderma spp., Thielaviopsis spp., Rhizopus spp., Mucor spp., Corticium spp., Phoma spp., Diplodia spp., Verticillium spp., Puccinia spp. and Mycosphaerella spp.

Examples of the weed include the followings:

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae weeds: Portulaca oleracea

Caryophyllaceae weeds: Stellaria media, Cerastium holosteoides, Cerastium glomeratum, Spergula arvensis, Silene gallica

Aizoaceae weeds: Mollugo verticillata

Chenopodiaceae weeds: Chenopodium album, Chenopodium ambrosioides, Kochia scoparia, Salsola kali, Atriplex spp.

Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella

Papaveraceae weeds: Papaver rhoeas, Argemone mexicana

Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus

Capparaceae weeds: Cleome affinis

Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis

Oxalidaceae weeds: Oxalis corniculata, Oxalis strica, Oxalis oxyptera

Geraniaceae weeds: Geranium carolinense, Erodium cicutarium

Euphorbiaceae weeds: Euphorbia helioscopia, Euphorbia maculata, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis

Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica

Violaceae weeds: Viola arvensis, Viola tricolor

Cucurbitaceae weeds: Sicyos angulatus, Echinocystis lobata, Momordica charantia

Lythraceae weeds: Lythrum salicaria

Apiaceae weeds: Hydrocotyle sibthorpioides

Sapindaceae weeds: Cardiospermum halicacabum

Primulaceae weeds: Anagallis arvensis

Asclepiadaceae weeds: Asclepias syriaca, Ampelamus albidus

Rubiaceae weeds: Galium aparine, Galium spurium var. echinospermon, Spermacoce latifolia, Richardia brasiliensis, Borreria alata

Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae weeds: Myosotis arvensis

Lamiaceae weeds: Lamium purpureum, Lamium amplexicaule, Leonotis nepetaefolia, Hyptis suaveolens, Hyptis lophanta, Leonurus sibiricus, Stachys arvensis

Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides

Scrophulariaceae weeds: Veronica hederaefolia, Veronica persica, Veronica arvensis

Plantaginaceae weeds: Plantago asiatica

Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis

Liliaceae weeds: Allium canadense, Allium vineale

Commelinaceae weeds: Commelina communis, Commelina bengharensis, Commelina erecta

Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae weeds: Cyperus microiria, Cyperus iria, Cyperus odoratus, Cyperus rotundus, Cyperus esculentus, Kyllinga gracillima

Equisetaceae weeds: Equisetum arvense, Equisetum palustre, and the like.

In the method of controlling a pest of the present invention, one or more kinds of other agrochemicals can be also used in combination simultaneously or separately with the compounds of the group (I) or the PPO inhibitor. Examples of the other agrochemicals include an insecticide, a miticide, a nematocide, a fungicide, a herbicide, a plant regulating agent and a safener.

Examples of the other agrochemicals include the followings:

Herbicide: dicamba and a salt thereof (diglycolamine salt, dimethylammonium salt, isopropylammonium salt, potassium salt, sodium salt, choline salt), 2,4-D and a salt or ester thereof (butotyl ester, dimethylammonium salt, diolamine salt, ethylhexyl ester, isooctyl ester, isopropylammonium salt, sodium salt, triisopropanolamine salt, choline salt), 2,4-DB and a salt or ester thereof (dimethylammonium salt, isooctyl ester, choline salt), MCPA and a salt or ester thereof (dimethylammonium salt, 2-ethylhexyl ester, isooctyl ester, sodium salt, choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or ester thereof (dimethylammonium salt, 2-ethylhexyl ester, isobutyl salt, potassium salt, choline salt), dichlorprop and a salt or ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, benzobicyclon, dithiopyr, triclopyr and a salt or ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat and diquat-dibromide

Plant growth regulating agents: hymexazol, paclobutrazol, uniconazole, uniconazole-P, inabenfide, prohexadione-calcium, 1-methylcyclopropene, trinexapac and gibberellins.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride and oxabetrinil.

### EXAMPLES

The present invention will be described below by way of examples, but the present invention is not limited to these examples. In the following description, “ha” means hectare, that is, 10000 m².

First, evaluation criteria of insecticidal activity, herbicidal activity and phytotoxicity on crop shown in the following examples will be shown.

### [Insecticidal Activity]

For evaluating the insecticidal activity, life or death of an insect at investigation is determined, and a controlling value is obtained by the following equation:

Controlling value(%)=100×(1−T/C)

Letters in the equation represent the following meanings.

C: Number of insects at observation of non-treated section
T: Number of insects at observation of treated-section

### [Herbicidal Activity and Phytotoxicity on Crop]

Evaluation of herbicidal activity is classified into 0 to 100, letting no or little difference when the state of germination or growth of a test weed at investigation is compared with that of non-treatment to be “0”, and letting complete withering of a test weed or complete inhibition of germination or growth to be “100”.

For evaluation of phytotoxicity on a crop, when phytotoxicity is hardly perceived, it is represented by “no damage”, when slight phytotoxicity is perceived, it is represented by “slight”, when moderate phytotoxicity is perceived, it is represented by “moderate”, and when severe phytotoxicity is perceived, it is represented by “severe”. The “phytotoxicity” evaluated herein is a damage characteristic determined to be caused by the treated compound, and is clearly discriminated from a damage characteristic caused by a pest.

### Example 1

Into a plastic cup having an internal diameter of 96 millimeters and a height of 44 millimeters are placed 25 microliters of a clothianidin suspension (suspension containing 600 g/L clothianidin, trade name: NipsIt INSIDE, manufactured by Valent USA) and 50 grains of cotton seeds. By shaking this plastic cup with a hand, the clothianidin suspension is attached to the cotton seeds.

Into a pot made of a plastic having an internal diameter of 177 millimeters and a height of 140 millimeters is packed a soil in which each of about 500 milligrams of seeds of Conyza canadensis, Amaranthus palmeri and Chenopodium album are mixed. A liquid of a flumioxazin water dispersible granule (water dispersible granule containing 51% of flumioxazin, trade name: Valor SX, manufactured by Valent USA) diluted with water is uniformly sprayed on the soil surface of this pot with a sprayer, so that flumioxazin is applied in an amount of 50 or 75 g/ha. Fifteen days after spraying, the cotton seeds are seeded at 5 grains per pot.

Fifteen days after seeding with the cotton seeds, a cotton leaf piece on which 20 larvae and 20 adults of Aphis gossypii inhabited is placed in the pot, and the whole plant is covered with a nylon cloth.

Six days after release of Aphis gossypii, the insecticidal activity, herbicidal activity and phytotoxicity are determined, and high weed controlling activity (>80) and high Aphis gossypii control value (>70) are obtained, and the phytotoxicity on the cotton is “no damage”.

### Example 2

Into a plastic cup having an internal diameter of 96 millimeters and a height of 44 millimeters are placed 25 microliters of a thiamethoxam preparation (preparation containing 600 g/L thiamethoxam, trade name: Cruiser 5FS, manufactured by Syngenta) and 50 grains of cotton seeds. By shaking this plastic cup with a hand, the thiamethoxam preparation is attached to the cotton seeds.

Into a pot made of a plastic having an internal diameter of 177 millimeters and a height of 140 millimeters is packed a soil in which each of about 500 milligrams of seeds of Conyza canadensis, Amaranthus palmeri and Chenopodium album are mixed. A liquid of a flumioxazin water dispersible granule (water dispersible granule containing 51% of flumioxazin, trade name: Valor SX, manufactured by Valent USA) diluted with water is uniformly sprayed on the soil surface of this pot with a sprayer, so that flumioxazin is applied in an amount of 50 or 75 g/ha. Fifteen days after spraying, the cotton seeds are seeded at 5 grains per pot.

Fifteen days after seeding with the cotton seeds, a cotton leaf piece on which 20 larvae and 20 adults of Aphis gossypii inhabited is placed in the pot, and the whole plant is covered with a nylon cloth.

Six days after release of Aphis gossypii, the insecticidal activity, herbicidal activity and phytotoxicity are determined, and high weed controlling activity (>80) and high Aphis gossypii control value (>70) are obtained, and the phytotoxicity on the cotton is “no damage”.

### Example 3

In combinations shown in Table 1 and Table 2, a controlling effect against a weed and phytotoxicity on a crop can be confirmed according to the aforementioned criteria, by the following method.

A soil is packed into a pot, a weed is seeded, and the soil surface is uniformly treated with a PPO-inhibiting compound. After 15 days, cotton seeds with the compound of the group (I) attached thereto are seeded. This pot is placed in a greenhouse. Fifteen days after seeding, the herbicidal activity against the weed is investigated.

TABLE 1

| Combination | Compound of group (I) | PPO-inhibiting compound |
|---|---|---|
| 1-1 | Imidacloprid | Flumioxazin |
| 1-2 | Clothianidin | Fomesafen |
| 1-3 | Thiamethoxam | Fomesafen |
| 1-4 | Imidacloprid | Fomesafen |
| 1-5 | Clothianidin | Oxyfluorfen |
| 1-6 | Thiamethoxam | Oxyfluorfen |
| 1-7 | Imidacloprid | Oxyfluorfen |
| 1-8 | Clothianidin | Saflufenacil |
| 1-9 | Thiamethoxam | Saflufenacil |
| 1-10 | Imidacloprid | Saflufenacil |
| 1-11 | Clothianidin | Compound A |
| 1-12 | Thiamethoxam | Compound A |
| 1-13 | Imidacloprid | Compound A |
| 1-14 | Myclobutanil | Flumioxazin |
| 1-15 | Triadimenol | Flumioxazin |
| 1-16 | Difenoconazole | Flumioxazin |
| 1-17 | Prothioconazole | Flumioxazin |
| 1-18 | Metconazole | Flumioxazin |
| 1-19 | Tebuconazole | Flumioxazin |
| 1-20 | Triticonazole | Flumioxazin |

TABLE 2

| Combination | Compound of group (I) | PPO-inhibiting compound |
|---|---|---|
| 1-21 | Ipconazole | Flumioxazin |
| 1-22 | Fluquinconazole | Flumioxazin |
| 1-23 | Myclobutanil | Fomesafen |
| 1-24 | Triadimenol | Fomesafen |
| 1-25 | Difenoconazole | Fomesafen |
| 1-26 | Prothioconazole | Fomesafen |
| 1-27 | Metconazole | Fomesafen |
| 1-28 | Tebuconazole | Fomesafen |
| 1-29 | Triticonazole | Fomesafen |
| 1-30 | Ipconazole | Fomesafen |
| 1-31 | Fluquinconazole | Fomesafen |
| 1-32 | Azoxystrobin | Flumioxazin |
| 1-33 | Pyraclostrobin | Flumioxazin |
| 1-34 | Trifloxystrobin | Flumioxazin |
| 1-35 | Azoxystrobin | Fomesafen |
| 1-36 | Pyraclostrobin | Fomesafen |
| 1-37 | Trifloxystrobin | Fomesafen |
| 1-38 | Metalaxyl | Flumioxazin |
| 1-39 | Metalaxyl-M | Flumioxazin |
| 1-40 | Metalaxyl | Fomesafen |
| 1-41 | Metalaxyl-M | Fomesafen |

### Example 4

In combinations shown in Table 3 and Table 4, a controlling effect against a weed and phytotoxicity on a crop can be confirmed according to the aforementioned criteria, by the following method.

The compound of the group (I) is attached to each of cotton seeds. Then, the seeds are seeded on a cultivated land. Thirty days after seeding, in the state where the main stem of cotton is lignified 15 cm from the ground surface, the cultivated land is subjected to Post-directed treatment with PPO-inhibiting compound. Twenty eight days after the treatment, the herbicidal activity against a weed is investigated.

TABLE 3

| Combination | Compound of group (I) | PPO-inhibiting compound |
|---|---|---|
| 2-1 | Clothianidin | Flumioxazin |
| 2-2 | Thiamethoxam | Flumioxazin |
| 2-3 | Imidacloprid | Flumioxazin |
| 2-4 | Clothianidin | Fomesafen |
| 2-5 | Thiamethoxam | Fomesafen |
| 2-6 | Imidacloprid | Fomesafen |
| 2-7 | Clothianidin | Oxyfluorfen |
| 2-8 | Thiamethoxam | Oxyfluorfen |
| 2-9 | Imidacloprid | Oxyfluorfen |
| 2-10 | Clothianidin | Saflufenacil |
| 2-11 | Thiamethoxam | Saflufenacil |
| 2-12 | Imidacloprid | Saflufenacil |
| 2-13 | Clothianidin | Compound A |
| 2-14 | Thiamethoxam | Compound A |
| 2-15 | Imidacloprid | Compound A |
| 2-16 | Myclobutanil | Flumioxazin |
| 2-17 | Triadimenol | Flumioxazin |
| 2-18 | Difenoconazole | Flumioxazin |
| 2-19 | Prothioconazole | Flumioxazin |
| 2-20 | Metconazole | Flumioxazin |

TABLE 4

| Combination | Compound of group (I) | PPO-inhibiting compound |
|---|---|---|
| 2-21 | Tebuconazole | Flumioxazin |
| 2-22 | Triticonazole | Flumioxazin |
| 2-23 | Ipconazole | Flumioxazin |
| 2-24 | Fluquinconazole | Flumioxazin |
| 2-25 | Myclobutanil | Fomesafen |
| 2-26 | Triadimenol | Fomesafen |
| 2-27 | Difenoconazole | Fomesafen |
| 2-28 | Prothioconazole | Fomesafen |
| 2-29 | Metconazole | Fomesafen |
| 2-30 | Tebuconazole | Fomesafen |
| 2-31 | Triticonazole | Fomesafen |
| 2-32 | Ipconazole | Fomesafen |
| 2-33 | Fluquinconazole | Fomesafen |
| 2-34 | Azoxystrobin | Flumioxazin |
| 2-35 | Pyraclostrobin | Flumioxazin |
| 2-36 | Trifloxystrobin | Flumioxazin |
| 2-37 | Azoxystrobin | Fomesafen |
| 2-38 | Pyraclostrobin | Fomesafen |
| 2-39 | Trifloxystrobin | Fomesafen |
| 2-40 | Metalaxyl | Flumioxazin |
| 2-41 | Metalaxyl-M | Flumioxazin |
| 2-42 | Metalaxyl | Fomesafen |
| 2-43 | Metalaxyl-M | Fomesafen |

According to the method of controlling a pest of the present invention, a pest in a field of cotton can be effectively controlled.

What is claimed is:

1. A method of controlling a weed in a field of cotton, comprising applying one or more PPO-inhibiting compounds selected from the group consisting of flumioxazin, sulfentrazone, saflufenacil, oxyfluorfen, fomesafen and a compound of the formula: 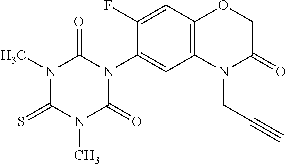 [SMILES: C#CCN1C(=O)COc2cc(F)c(-n3c(=O)n(C)c(=S)n(C)c3=O)cc21]
to a field before, at or after seeding with a seed of cotton treated with one or more compounds selected from the group consisting of a neonicotinoid compound, an azole compound, a strobilurin compound and a metalaxyl compound.

2. A method of controlling a pest in a field of cotton, comprising steps of:
treating a seed of cotton with one or more compounds selected from the group (I) consisting of a neonicotinoid compound, an azole compound, a strobilurin compound and a metalaxyl compound, and
treating a field before, at or after seeding with the seed of cotton treated with one or more compounds selected from the group (I), with one or more PPO-inhibiting compounds selected from the group consisting of flumioxazin, sulfentrazone, saflufenacil, oxyfluorfen, fomesafen and a compound of the formula:

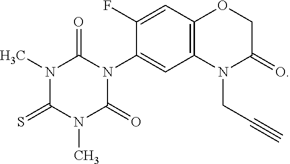 [SMILES: C#CCN1C(=O)COc2cc(F)c(-n3c(=O)n(C)c(=S)n(C)c3=O)cc21]

3. The method of controlling a pest according to claim 1 or 2, wherein the neonicotinoid compound is one selected from the group consisting of clothianidin, thiamethoxam, imidacloprid, dinotefuran, nitenpyram, acetamiprid and thiacloprid.

4. The method of controlling a pest according to claim 1 or 2, wherein the neonicotinoid compound is clothianidin or thiamethoxam.

5. The method of controlling a pest according to claim 4, wherein the PPO-inhibiting compound is flumioxazin or fomesafen.

6. The method of controlling a pest according to claim 1 or 2, wherein the azole compound is one selected from the group consisting of azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz and triflumizole.

7. The method of controlling a pest according to claim 1 or 2, wherein the azole compound is one selected from the group consisting of difenoconazole, ipconazole, metconazole, tebuconazole, triadimenol, myclobutanil, triticonazole and fluquinconazole.

8. The method of controlling a pest according to claim 7, wherein the PPO-inhibiting compound is flumioxazin or fomesafen.

9. The method of controlling a pest according to claim 1 or 2, wherein the strobilurin compound is one selected from the group consisting of kresoxim-methyl, azoxystrobin, trifloxystrobin, fluoxastrobin, picoxystrobin, pyraclostrobin, dimoxystrobin, pyribencarb, metominostrobin and orysastrobin.

10. The method of controlling a pest according to claim 1 or 2, wherein the strobilurin compound is azoxystrobin, trifloxystrobin or pyraclostrobin.

11. The method of controlling a pest according to claim 10, wherein the PPO-inhibiting compound is flumioxazin or fomesafen.

12. The method of controlling a pest according to claim 1 or 2, wherein the metalaxyl compound is metalaxyl or metalaxyl-M.

13. The method of controlling a pest according to claim 12, wherein the PPO-inhibiting compound is flumioxazin or fomesafen.

14. The method of controlling a pest according to claim 2, comprising a step of treating the field before seeding with the seed of cotton, with the PPO-inhibiting compound.

15. The method of controlling a pest according to claim 2, comprising a step of treating the field to be seeded, with the PPO-inhibiting compound simultaneously at seeding with the seed of cotton.

16. The method of controlling a pest according to claim 2, comprising a step of treating the field after seeding with the seed of cotton, with the PPO-inhibiting compound.

17. The method of controlling a pest according to claim 2, wherein the pest is a weed, a harmful arthropod, and/or a plant pathogen.

18. The method of controlling a pest according to claim 2, wherein the pest is a weed.
